(19) United States
(12) Patent Application Publication
(10) Pub. No.: US 2017/0194709 A1
(43) Pub. Date: Jul. 6, 2017

(54) Multi-Structure Metal Antenna

(71) Applicant: Daniel Jansson, Shenzhen (CN)

(72) Inventor: Daniel Jansson, Shenzhen (CN)

(73) Assignee: AAC Acoustic Technologies (Shenzhen) Co., Ltd., Shenzhen (CN)

(21) Appl. No.: 14/985,916

(22) Filed: Dec. 31, 2015

(51) Int. Cl. H01Q 7/00; H01Q 1/24; H01Q 13/18; H01Q 1/50; H01Q 9/04; H01Q 1/42

(52) U.S. Cl. CPC H01Q 7/00; H01Q 9/04; H01Q 1/42; H01Q 13/18; H01Q 1/50; H01Q 1/24

(57) ABSTRACT

Disclosed is a multi-structure metal antenna. The antenna includes a metal cover, a metal ring, an isolated unit spacing the metal cover apart from the metal ring, a ground plane and at least one feed terminal and at least one ground terminal located on the metal cover and/or the metal ring serving as an antenna radiator.

### FIELD OF THE INVENTION

The disclosure described herein relates generally to electronic devices, and more particularly, to a multi-structure metal antenna used in the electronic devices.

### DESCRIPTION OF RELATED ART

Portable electronic devices are becoming increasingly popular. Due in part of their mobile nature, electronic devices are often provided with wireless communications capabilities and more and more antennas are required in such electronic devices. A minimum is 3: one main cellular, one MIMO/diversity (Multiple-Input Multiple-Output) and one Bluetooth/WIFI/GPS. Additionally, there may be 2 additional antennas for cellular and MIMO to ensure good performance across a range of bands: an additional WIFI MIMO, potentially a separate antenna for cellular Tx MIMO, and in some cases the GPS is a separate antenna. The expected future configuration may be 8 antennas within a mobile phone, but this could increase further as new band combinations become available and MIMO 4x4 enters mobile devices.

While the number of antennas needs to increase, the market trend is for small size and metal casings electronic devices. In related technologies, a single metal casing is used with a number of slots to achieve performance which limits the number of antennas that may be created. Further, the antennas will have similar radiation characteristics that may overall limit the performance of the electronic device.

This is a conflicting challenge for manufacturers to reduce the size of components that are used in these devices and increase the number of antennas at the same time. Although modern electronic devices often need to function over a number of different communications bands, it is difficult to design a compact antenna that covers all frequency bands of interest, especially a metal structure does not lend itself well to multiple antennas.

Therefore, an improved multi-structure metal antenna is provided in the present disclosure to solve the problem mentioned above.

### BRIEF DESCRIPTION OF THE DRAWINGS

FIG. 1 illustrates an assembled view of a multi-structure metal antenna in accordance with a first embodiment of the present disclosure.

FIG. 2 illustrates an exploded view of the multi-structure metal antenna illustrated in FIG. 1.

FIG. 3 illustrates a diagram of a matching network of the multi-structure metal antenna in FIG. 1.

FIG. 4 illustrates an isometric view of a multi-structure metal antenna in accordance with a second embodiment of the present disclosure.

FIG. 5 illustrates an isometric view of a multi-structure metal antenna in accordance with a third embodiment of the present disclosure.

FIG. 6 illustrates an isometric view of a multi-structure metal antenna in accordance with a fourth embodiment of the present disclosure.

FIG. 7 illustrates an isometric view of a multi-structure metal antenna in accordance with a fifth embodiment of the present disclosure.

FIG. 8 illustrates an isometric view of a multi-structure metal antenna in accordance with a sixth embodiment of the present disclosure.

FIG. 9 illustrates an assembled view of an electronic device in accordance with an exemplary embodiment of the present disclosure.

FIG. 10 illustrates an exploded view of the electronic device illustrated in FIG. 9.

Many aspects of the embodiments can be better understood with reference to the drawings mentioned above. The components in the drawings are not necessarily drawn to scale, the emphasis instead being placed upon clearly illustrating the principles of the present disclosure. Moreover, in the drawings, like reference numerals designate corresponding parts throughout the several views.

### DETAILED DESCRIPTION OF THE EXEMPLARY EMBODIMENTS

Reference will now be made to describe the exemplary embodiments of the present invention in detail.

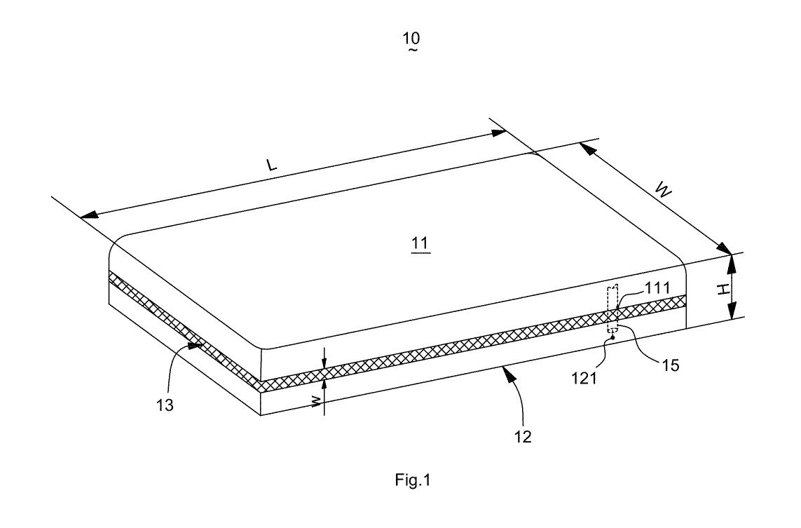

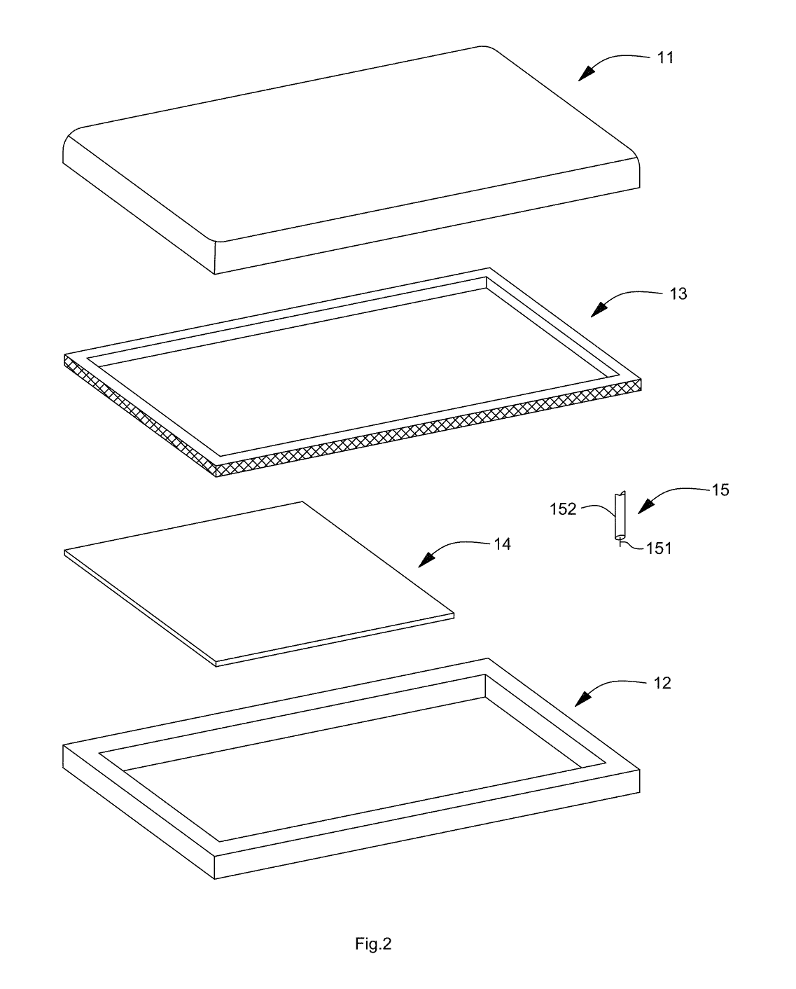

Referring to FIGS. 1-3, the first embodiment provides a multi-structure metal antenna 10 used in various electronic devices. The portable mobile devices may be, for example, mobile phones, handheld computers, handheld gaining devices, notebooks, MP3 players designed to operate in a cellular or WIFI network. The multi-structure metal antenna 10 comprises a metal cover 11, a metal ring 12 running around at the edges of the metal cover 11, an isolated unit 13 sandwiched between the metal cover 11 and the metal ring 12 for connecting the metal cover 11 and the metal ring 12 and electrically isolating the metal cover 11 and the metal ring 12, and a ground plane 14.

The metal cover 11 has a length L, a width W perpendicular to the length L and a height H perpendicular to the length L and the width W, respectively. Obviously, the metal ring 12 has the same shape with the metal cover 11, and the materials of the metal cover 11 and the metal ring 12 can be the same or different. The materials of the metal cover 11 and the metal ring 12 are selected from aluminum alloy, stainless steel, magnesium alloy, a zinc alloy, titanium or other structurally sound materials with good electrical properties, respectively. The metal cover 11 and the metal ring 12 are typically produced through stamping, die-casting or extrusion followed by CNC (Computer Numerical Control). A metal cover with simple structure may be manufactured through only a stamping process.

A gap having a width w and formed between the metal cover 11 and the metal ring 12 is dielectric-filled with plastic or other dielectric materials by molding process, such as a nano molding technology or similar type of technology. The isolated unit 13 is made of plastic or similar dielectric materials and is assembled with the metal cover 11 and the metal ring 12 through molding process, thereby ensuring the strong bonds between the metal cover 11 and the metal ring 12. That is to say, the material of the isolated unit is dielectric and it can be selected from plastic (like PBT (polybutylene Terephthalate) or PPS (Polyphenylene Sulfide)). But as materials research is very active in this field, other materials may be used as they become available to nano molding technology. Furthermore, the plastic may be mixed with glass fiber to increase structural strength or may be mixed with additional additives to modify the electrical properties of the material, such as increase the dielectric constant. A change in dielectric constant is done to optimize the antenna performance. The gap positioned between the metal cover 11 and the metal ring 12 may also be filled with a ceramic material. The ceramic material is a premium material for offering designer's additional choice in structures and visual appearance as well as improving the antenna performance. Ceramic materials have a wide range of dielectric properties that can be chosen to optimize the antenna performance.

The antenna 10 which operates as a slot antenna is fed using the arrangement of FIG. 1. The antenna 10 further comprises a feed terminal 121 located on the metal ring 12, a ground terminal 111 located on the metal cover 11 and a coaxial cable 15 across the gap described above. The coaxial cable 15 can be other transmission line. In this embodiment, the metal cover 11 is electrically shorted to the ground plane 14 and the coaxial cable 15 includes an inner conductor 151 and an outer braid ground conductor 152. The inner conductor 151 is connected to the feed terminal 121 and the outer braid ground conductor 152 is connected to the ground terminal 111.

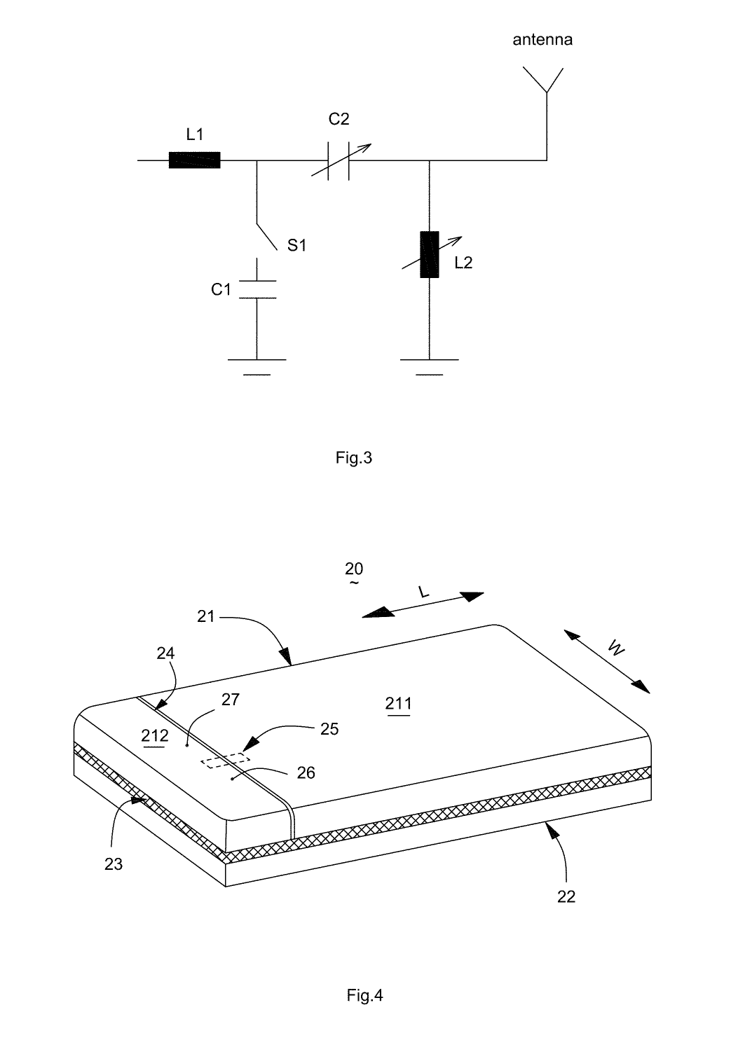

In addition, the multi-structure metal antenna 10, may further include a matching network, for example as arranged in FIG. 3. The matching network is capable of adjusting the performance of the multi-structure metal antenna 10 and helps the multi-structure metal antenna 10 to operate in different frequency bands. The matching network includes an inductor L1, a capacitor C1 connected to the inductor L1 in parallel, a switch Si for controlling the capacitor C1 connected to the capacitor C1 in serial, a variable capacitor C2 connected to the inductor L1 in serial, and an additional inductor L2 connected to the variable capacitor C2 in parallel. Many different topologies are available for matching networks, and this multi-structure metal antenna 10 shall not be limited to specific topologies. In other exemplary embodiment, the matching network can further include a switch for controlling whether the metal cover 11 or metal ring 12 is electrically shorted to the ground plane 14 or not.

Referring to FIG. 4, the second embodiment provides a multi-structure metal antenna 20. The multi-structure metal antenna 20 comprises a metal cover 21, a metal ring 22 running around at the edges of the metal cover 21, an isolated unit 23 sandwiched between the metal cover 21 and the metal ring 22, a ground plane (not shown).

The metal cover 21 has a length L, a width W perpendicular to the length L and a dielectric-filled slot 24 extending along a direction parallel to the width W which divides the metal cover 21 into a smaller metal structure served as an antenna radiator 212 and a larger metal structure 211. The larger metal structure 211 is electrically shorted to the ground plane and the antenna radiator 212 may be electrically connected to the larger metal structure 211 through a conductor 25. The conductor 25 may be a metal piece or other conductive unit.

Same as the first embodiment, the materials of the metal cover 21 and the metal ring 22 can be the same or different. The materials used to make the metal cover 21 and the metal ring 22 can be selected from aluminum, stainless steel, magnesium alloy, a zinc alloy or other structurally sound materials with good electrical properties. The metal cover 21 and the metal ring 22 are typically produced through a die-casting or extrusion followed by CNC (Computer Numerical Control). The metal cover with simple structure may be manufactured through a stamping process.

A gap having a width and formed between the metal cover 21 and the metal ring 22 is dielectric-filled with plastic or other dielectric materials by a nano molding process or similar type of technology. That is to say, the isolated unit 23 is made of plastic or similar dielectric materials and is assembled with the metal cover 21 and the metal ring 22 through molding process, thereby ensuring the strong bonds between the metal cover 21 and the metal ring 22. The material of the isolated unit 23 is dielectric and it can be selected from plastic (like PBT (Polybutylene Terephthalate) or PPS (Polyphenylene Sulfide)). But as materials research is very active in this field, other materials may be used as they become available to nano molding technology. Furthermore, the plastic may also be mixed with glass fiber to increase structural strength or may be mixed with additional additives to modify the electrical properties of the material, such as increase the dielectric constant. A change in dielectric constant is done to optimize the antenna performance. The gap between the metal cover 21 and the metal ring 22 may also be filled with a ceramic material. The ceramic material is a premium material for offering designer's additional choice in structures and visual appearance as well as improving the antenna performance. Ceramic materials have a wide range of dielectric properties that can be chosen to optimize the antenna performance.

The antenna 10 is fed using the arrangement of FIG. 4. The antenna 10 module further comprises a first feed terminal 26 located on the antenna radiator 212 and a second feed terminal 27 located on the antenna radiator 212. The first feed terminal 26 is positioned on one side of the conductor 25 and the second feed terminal 27 is positioned on the other side of the conductor 25. Moreover, the antenna 20 can have more feed terminals or ground terminals.

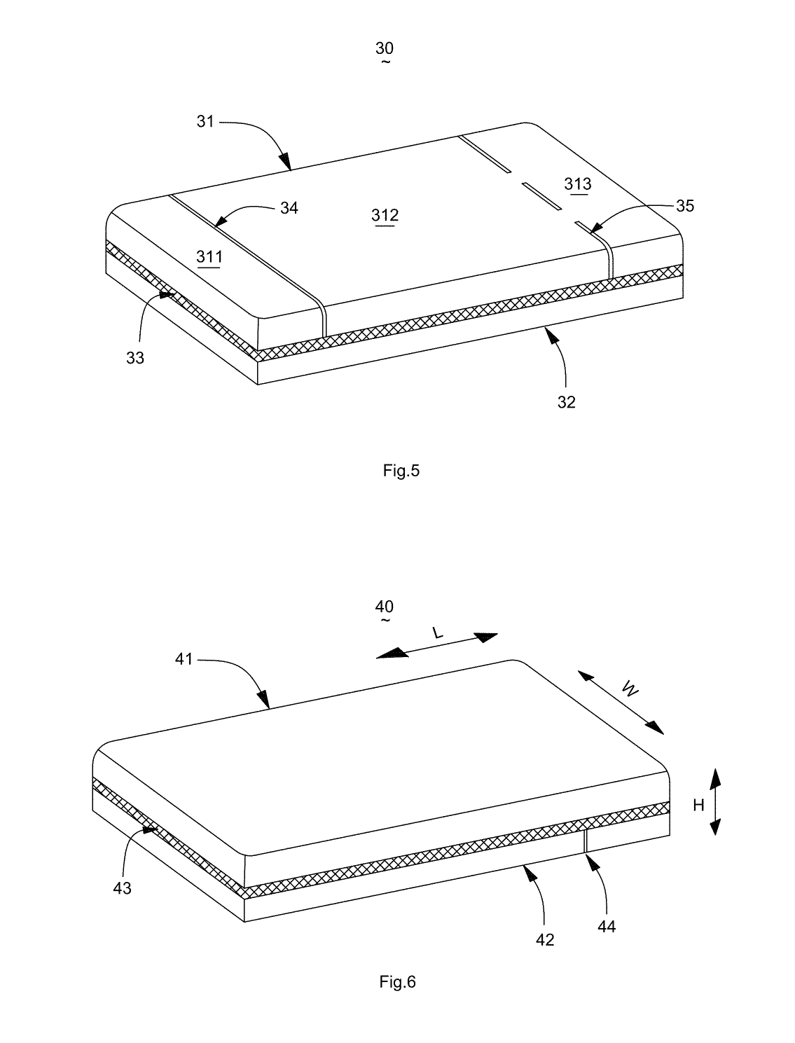

Referring to FIG. 5, as an improved embodiment of the second embodiment, the third embodiment provides a multi-structure metal antenna 30. The multi-structure metal antenna 30 comprises a metal cover 31, a metal ring 32 running around at the edges of the metal cover 31, an isolated unit 33 sandwiched between the metal cover 31 and the metal ring 32, and a ground plane (not shown).

Which is different from the second embodiment is that the metal cover 31 having a first dielectric-filled slot 34 and a second dielectric-filled slot 35. The first dielectric-filled slot 34 and the second dielectric-filled slot 35 divide the metal cover 31 into three parts: the top portion 311 served as an antenna radiator, the middle portion 312 electrically shorted to the ground plane and a bottom portion served 313 as another antenna radiator. Based aforementioned structure, various antenna modules can be designed. In this embodiment, the second dielectric-filled slot 35 is discontinuous to form a complex metal structure which would have enhanced antenna performance and ability to design for different frequency bands and the discontinuous slot 35 can be hidden to the end-user by advanced manufacturing technologies.

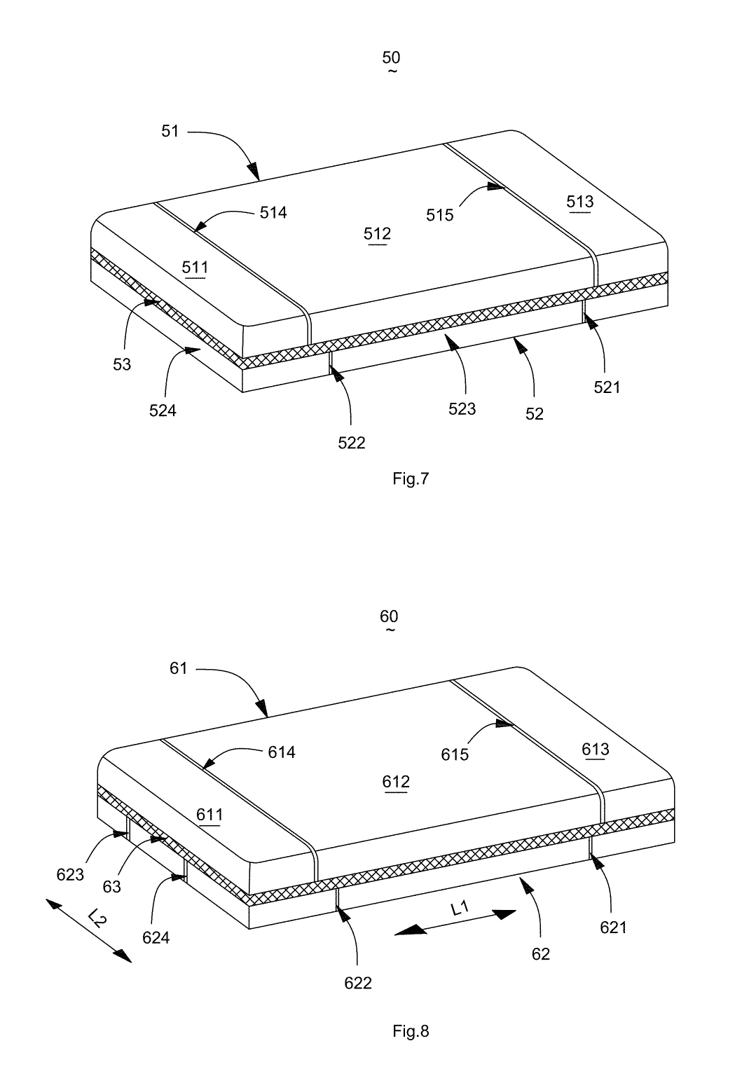

Referring to FIG. 6, the fourth embodiment provides a multi-structure metal antenna 40. The multi-structure metal antenna 40 comprises a metal cover 41, a metal ring 42 running around at the edges of the metal cover 41, an isolated unit 43 sandwiched between the metal cover 41 and the metal ring 42, and a ground plane (not shown).

The metal cover 41 has a length L, a width W perpendicular to the length L and a height H perpendicular to the length L and the width W. The metal ring 42 has a dielectric-filled gap 44 extending along the direction of the height H. Similarly, the antenna 40 operating as a slot/notch antenna could include at least one feed terminal and at least one ground terminal (not shown), and even a matching network.

Referring to FIG. 7, as a combination of the third embodiment and the fourth embodiment and an improved embodiment of the fourth embodiment, the fifth embodiment provides a multi-structure metal antenna 50. The multi-structure metal antenna 50 comprises a metal cover 51, a metal ring 52 running around at the edges of the metal cover 51, an isolated unit 53 sandwiched between the metal cover 51 and the metal ring 52, and a ground plane (not shown).

In this embodiment, the metal cover 51 has a first dielectric-filled slot 514 and a second dielectric-filled slot 515 extending along the direction of width. The first dielectric-filled slot 514 and the second dielectric-filled slot 515 divide the metal cover 51 into three parts: the top portion 511 served as an antenna radiator, the middle portion 512 electrically shorted to the ground plane and a bottom portion served 513 as another antenna radiator. The metal ring 52 has a first dielectric-filled gap 521 extending along the direction of height and a second dielectric-filled gap 522 parallel to the first dielectric-filled gap 521. The first dielectric-filled gap 521 and the second dielectric-filled gap 522 divide the metal ring 52 into two parts: a small metal structure 523 served as an additional radiator and a large metal structure 524 electrically shorted to the ground plane. Based on aforementioned structure, various antenna modules can be designed. Similarly, the first or the second dielectric-filled slot can be discontinuous to create a complex metal structure which would have enhanced antenna performance and ability to design for different frequency bands and the discontinuous slots can be hidden to the end-user by advanced manufacturing technologies.

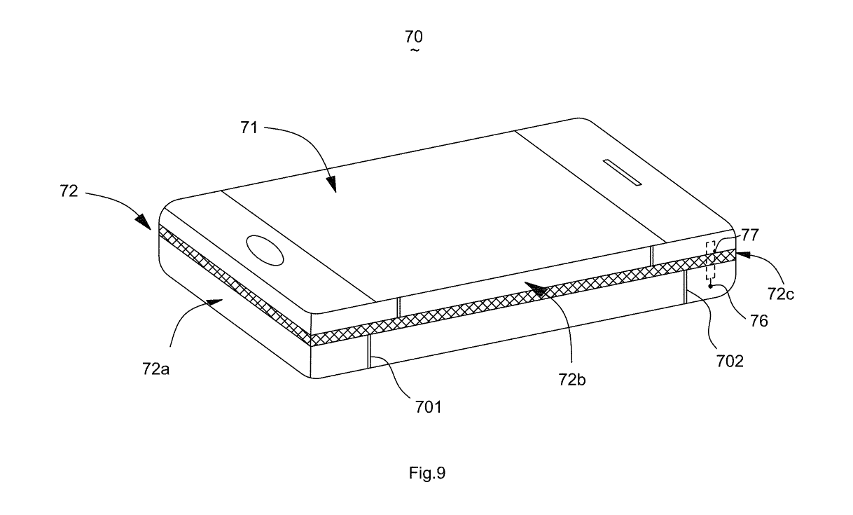

Referring to FIG. 8, as an improved embodiment of the fifth embodiment, the sixth embodiment provides a multi-structure metal antenna 60. The multi-structure metal antenna 60 comprises a metal cover 61, a metal ring 62 running around at the edges of the metal cover 61, an isolated unit 63 sandwiched between the metal cover 61 and the metal ring 62, and a ground plane (not shown). The metal ring 62 has a first side L1 and a second side L2 perpendicular to the first side L1.

In this embodiment, the metal cover 61 has a first dielectric-filled slot 614 and a second dielectric-filled slot 615 extending along the direction of the second side L2. The first dielectric-filled slot 614 and the second dielectric-filled slot 615 divide the metal cover 61 into three parts: the top portion 611 served as an antenna radiator, the middle portion 612 electrically shorted to the ground plane and a bottom portion served 613 as another antenna radiator. The metal ring 62 has a first dielectric-filled gap 621 extending along the direction of height, a second dielectric-filled gap 622 parallel to the first dielectric-filled gap 621, a third dielectric-filled gap 623 and a fourth dielectric-filled gap 624. The first dielectric-filled gap 621 and the second dielectric-filled gap 622 are formed in the first side L1 and the third dielectric-filled gap 623 and the fourth dielectric-filled gap 624 are formed in the second side L2. Based on aforementioned structure, various antenna modules can be designed. Similarly, the first or the second dielectric-filled slot can be discontinuous to create a complex metal structure which would have enhanced antenna performance and ability to design for different frequency bands and the discontinuous slots can be hidden to the end-user by advanced manufacturing technologies.

As described in the six embodiments, a number of surface finishing technologies may subsequently be applied. Examples of these are anodizing polishing, sand blasting, PVD (Physical Vapor Deposition), NCVM (Non-Conductive Vacuum Metalize) and painting. Additional anti-fingerprint coatings may also be applied. Manufacturing technologies may also allow for hiding of the separates or slots between structures.

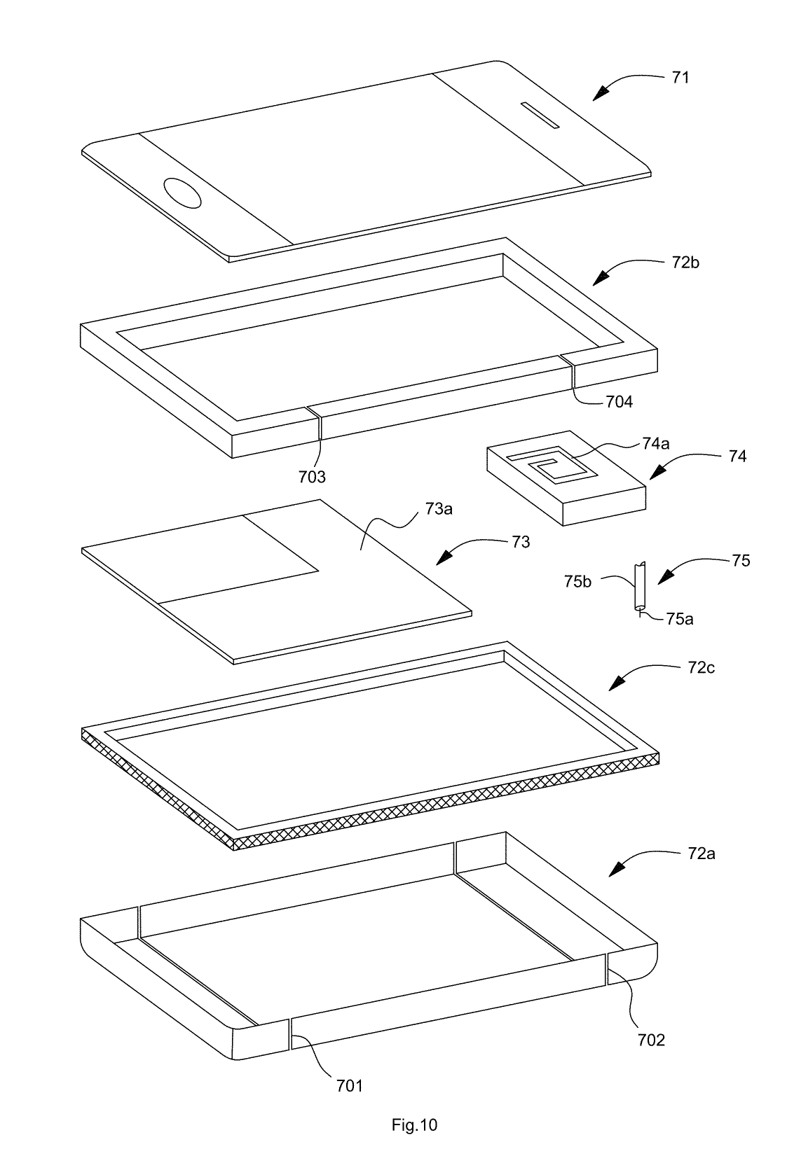

Referring to FIGS. 9-10, the exemplary embodiment provides a electronic device 70 comprising a metal housing 72, a display 71 mounted in the metal housing 72, a circuit board 73 having a ground plane 73a received in the metal housing 72, and a speaker box 74 received in the metal housing 72 and an antenna module (not shown).

The metal housing 72 comprises a metal cover 72a, a metal ring 72b running around at the edges of the metal cover 72a and an isolated unit 72c spacing the metal cover 72a apart from the metal ring 72b. The materials of the metal cover 72a and the metal ring 72b can be the same or different. The materials used to make the metal cover 72a and the metal ring 72b can be selected from various metallic materials with good electrical properties. The metal cover 72a is a rectangular like unit and has a first dielectric-filled slot 701 and a second dielectric-filled slot 702 extending a direction along the width of the metal cover 72a. The first dielectric-filled slot 701 and the second dielectric-filled slot 702 divide the metal cover 72a into a top part, a middle part and a bottom part. The top part and the bottom part serve as antenna radiators and the middle part is electrically shorted to the ground plane 73a. The metal ring 72b is also a rectangular like unit and it also has two dielectric-filled slots 703 and 704 which divide the metal ring 71b into a small metal part and a large part. The small part is capable of serving as the antenna radiator and the large part is electrically shorted to the ground plane 73a.

The isolated unit 72c is made from plastic or other dielectric materials that is molded by a nano molding technology or similar type of technology. The isolated unit 72c is made of plastic or similar dielectric materials and is assembled with the metal cover 72a and the metal ring 72b through molding process, thereby ensuring the strong bonds between the metal cover 72a and the metal ring 72b. That is to say, the material of the isolated unit is dielectric and it can be selected from plastic (like PBT (polybutylene Terephthalate), PPS (Polyphenylene Sulfide)), or even a ceramic material. The ceramic material is a premium material offering designers additional choice in structures and visual appearance as well as improving the antenna performance. Ceramic materials have a wide range of dielectric properties that can be chosen to optimize the antenna performance.

The antenna module in this embodiment is a slot/notch type antenna which includes a conductive cable 75 across the isolated unit 72c, a feed terminal 76 located on the top part of the metal cover 72a and a ground terminal 77 located on the large part on the metal ring 72b. The cable 75 has an inner conductor 75a connected to the feed terminal 76 and an outer braid conductor 75b connected to the ground terminal 77. Furthermore, the antenna module could further include at least one matching network or combination of the matching networks for providing expected antenna performance located on the circuit board 73 or integrated with the metal housing 72. The matching network could include discrete inductors and capacitors attached to either or both metal cover 72a or metal ring 72b. The matching network could further include a switch manufactured by an RF-MEMS technology, CMOS, GaAs, BST or GaN or similar semiconductor materials which is capable of switching in an additional ground terminal or switching the matching network.

Based on the dielectric-filled slots on the metal cover 72a and the metal ring 72b, various antennas having wide range of frequency can be designed.

The electronic device 70 could further include a radiator structure located in the metal housing 72 or a carrier in the metal housing 72 and operating in conjunction with the metal housing 72 to enhance the performance of the antenna module. The radiator structure is capable of provide the desired number of antennas and performance across all desired frequency bands. In the present disclosure, the radiator structure is a trace 74a formed on the speaker box 74 by LDS technology. The carrier is the plastic box of the speaker box 74.

While the present disclosure has been described with reference to the specific embodiment, the description of the disclosure is illustrative and is not to be construed as limiting the disclosure. Various of modifications to the present disclosure can be made to the exemplary embodiment by those skilled in the art without departing from the true spirit and scope of the disclosure as defined by the appended claims.

What is claimed is:

1. A multi-structure metal antenna, comprising:
a metal cover;
a metal ring extending along an edge of the metal cover;
an isolated unit connecting the metal cover to the metal ring and electrically isolating the metal cover from the metal ring;
a circuit board having a ground plane;
at least one feed terminal and at least one ground terminal located on the metal cover and/or the metal ring serving as an antenna radiator.

2. The multi-structure metal antenna as described in claim 1, wherein the metal cover has at least one dielectric-filled slot which at least partially divides the metal cover into at least two parts, one of which serves as the antenna radiator.

3. The multi-structure metal antenna as described in claim 2, wherein the at least one dielectric-filled slot comprises a first dielectric-filled slot and a second dielectric-filled slot located at opposing ends of the metal cover respectively which divides the metal cover into a top portion, a middle portion and a bottom portion, the top portion and the bottom portion serve as the antenna radiators, the middle portion electrically is connected to the ground plane.

4. The multi-structure metal antenna as described in claim 2, wherein at least one of the dielectric-filled slots is discontinuous.

5. The multi-structure metal antenna as described in claim 1, wherein the metal cover has a length, a width perpendicular to the length and a height perpendicular to the length and the width, the metal ring has at least one dielectric-filled gap extending along the direction of the height.

6. The multi-structure metal antenna as described in claim 2, wherein the metal cover has a length, a width perpendicular to the length and a height perpendicular to the length and the width, the metal ring has at least one dielectric-filled gap extending along the direction of the height.

7. The multi-structure metal antenna as described in claim 6, wherein the feed terminal is located on the metal ring at one side of the dielectric-filled gap and the ground terminal is located on the metal ring at the opposite side of dielectric-filled gap.

8. The multi-structure metal antenna as described in claim 6, wherein the at least one dielectric-filled gap comprises a first dielectric-filled gap and a second dielectric-filled gap which divide the metal ring into a small metal structure and a large metal structure, the large metal structure is electrically shorted to the ground plane.

9. The multi-structure metal antenna as described in claim 8, wherein the metal ring comprises a first side parallel to the length of the metal cover and a second side perpendicular to the first side, the first dielectric-filled gap and the second dielectric-filled gap are located at the first side.

10. The multi-structure metal antenna as described in claim 9, wherein the metal ring further has a third dielectric-filled gap and a fourth dielectric-filled gap located on the second side.

11. The multi-structure metal antenna as described in claim 1 further comprises at least one matching network located on the circuit board, or integrated with the metal cover and/or metal ring.

12. The multi-structure metal antenna as described in claim 11, wherein the at least one matching network includes at least one inductor and/or at least one capacitor.

13. The multi-structure metal antenna as described in claim 12, wherein the at least one capacitor is a variable capacitor.

14. The multi-structure metal antenna as described in claim 13, wherein the matching network further includes a switch which is capable of switching the antenna radiator to a ground terminal or the matching network.

15. The multi-structure metal antenna as described in claim 1, wherein the isolated unit is manufactured from plastic or ceramic material.

16. The multi-structure metal antenna as described in claim 15, wherein the isolated unit is manufactured from plastic material and the plastic material includes PBT or PPS.

17. The multi-structure metal antenna as described in claim 16, wherein the plastic material is mixed with glass fiber to increase the structural strength of the isolated unit.

18. The multi-structure metal antenna as described in claim 1, wherein the metal cover and the metal ring are manufactured from different materials.

19. The multi-structure metal antenna as described in claim 18, wherein the materials used to manufactured the metal cover and the metal ring are selected from stainless steel, aluminum alloy, zinc alloy, magnesium, or titanium.

20. A electronic device, comprising:
a metal housing having a metal cover, a metal ring arranged along an edge of the metal cover and an isolated unit spacing the metal cover apart from the metal ring;
a display mounted in the metal housing;
a circuit board having a ground plane and received in the metal housing;
at least one antenna module having at least one feed terminal and at least one ground terminal located on the metal cover and/or the metal ring for serving as an antenna radiator.

21. The electronic device as described in claim 20, wherein the metal cover or the metal ring has at least one dielectric-filled slot which divides the metal cover or the metal ring into at least two parts, one of the two parts serving as the antenna radiator.

22. The electronic device as described in claim 20, wherein the metal cover and the metal ring have at least one dielectric-filled slot which divides the metal cover and the metal ring into at least two parts, one of the two parts serving as the antenna radiator.

23. The electronic device as described in claim 20, wherein the antenna module further comprises a conductive cable across the isolated unit having an inner conductor and an outer braid ground conductor, one of which electrically connects with the metal cover and the other electrically connects with the metal ring.

24. The electronic device as described in claim 20, wherein the antenna module further comprises at least one matching network located on the circuit board or integrated into the metal housing.

25. The electronic device as described in claim 20 further comprises at least one radiator structure located in the metal housing and operating in conjunction with the metal housing to enhance the performance of the at least one antenna module.

26. The electronic device as described in claim 25, wherein the at least one radiator structure is located on the circuit board or a carrier received in the metal housing.

27. The electronic device as described in claim 26, wherein the at least one radiator structure is located on the carrier, the carrier is a plastic box or frame.

28. The electronic device as described in claim 27, wherein the radiator is formed on the carrier through LDS technology or conductive link printing.
